(19) United States
(12) Patent Application Publication
(10) Pub. No.: US 2026/0328800 A1
(43) Pub. Date: Oct. 22, 2026

(54) PRESSURE SENSING PROBE

(71) Applicant: OFFICE NATIONAL D'ETUDES ET DE RECHERCHES A'EROSPATIALES, Palaiseau (FR)

(72) Inventors: Philippe REIJASSE, Palaiseau (FR); Jean-Charles ABART, Palaiseau (FR)

(21) Appl. No.: 19/119,208

(22) PCT Filed: Oct. 12, 2023
(86) PCT No.: PCT/EP2023/078384

§ 371 Date: Apr. 8, 2025

(30) Foreign Application Priority Data
Oct. 13, 2022 (FR) FR2210507

(51) Int. Cl. G01P 5/165

(52) U.S. Cl. CPC G01P 5/165

(57) ABSTRACT

A pressure sensing probe includes a wall defining a tube into which a fluid can enter, and a pressure tap passing through the wall, from which tap the pressure is measured. The tube is open at both ends so as to channel the flow of fluid along the tube. The probe includes an obstacle having a front face, which faces the channelled flow of fluid and opposes this flow, the obstacle forming a projection on the wall and being dimensioned so as to create a stop region for stopping the fluid upstream and at the bottom of the front face, while allowing the fluid to flow around the obstacle, between the obstacle and the wall. The pressure tap is located in alignment with and upstream of the obstacle, in the stop region.

### TECHNICAL FIELD

The invention relates to a pressure sensing probe. This probe is used to sense the pressure of a fluid. In particular, it can be mounted on an aircraft to sense the pressure in a stop region.

### BACKGROUND

On board an airplane, systems for measuring the air pressure in flight are used so as to be able to subsequently calculate the Mach number of the airplane or its altitude. These systems generally comprise pressure sensing probes such as Pitot probes, static probes or Pitot-static probes (also so-called Prandtl antennas). All these probes consist of a sensing tube into which the air flow can enter.

The Mach number of an aircraft is generally calculated based on the measured stop pressure and the static pressure. In fluid dynamics, the stop pressure is the pressure at a stop point in a fluid flow. Yet, the measurement of the stop pressure obtained by means of current probes might be distorted by different phenomena.

First of all, the sensing tube could be fouled by debris or insects. To avoid the introduction of insects, current probes are covered when the aircraft is on the ground. Nevertheless, insects or debris could enter the probe as soon as it is uncovered.

Then, when flying under icing conditions or in heavy rain, despite heating of the probe and the presence of a purging device, the measurement of the stop pressure might be distorted because of the poor discharge of the water and of the crystals accumulated in the sensing tube, via the purging device.

Next, for concision, water, crystals, debris, insects and impurities present in the atmosphere, regardless of what they are, are jointly and individually referred to as “impurities”.

Patent FR3067115 describes a probe in which the bottom of the sensing tube is plugged by a rear wall, so as to stop the flow of the fluid and enable measurement of the stop pressure. This probe further has a drain hole machined at the centre of the rear wall of the tube (i.e. at the bottom of the tube). This small-diameter hole is intended to discharge impurities to the outside. Nonetheless, the drain hole being located in the axis of symmetry of the tube, impurities might accumulate around the hole, at the periphery of the rear wall, in the intersection area (i.e. in the corner) between the rear wall and the tube.

Hence, there is a need for a new pressure sensing probe allowing discharging impurities efficiently.

### General Description

A pressure sensing probe according to the invention comprises: a wall defining a tube into which a fluid can enter; and a pressure tap passing through the wall, from which tap the pressure is measured. The tube is open at both of its ends so as to channel the flow of the fluid along the tube. The probe comprises an obstacle having a front face, or upstream face, or frontal face, which faces the channelled flow of the fluid and opposes this flow. The obstacle forms a projection on the wall and is dimensioned so as to create a stop region of the fluid upstream and at the bottom of the front face, while enabling the fluid to flow around the obstacle, between the obstacle and the wall. The pressure tap is located in alignment with and upstream of the obstacle, in the stop region.

Such a probe has a simple and robust design, and its risk of fouling by impurities is limited. Furthermore, maintenance thereof is facilitated because the tube is open at its ends.

When such a probe is mounted on an aircraft, the impurities are discharged directly and efficiently by being entrained in the channelled flow of the fluid. This channelled flow is diverted away from the pressure tap, by the obstacle, which protects the pressure tap from the impurities. Nevertheless, if impurities were to be trapped at the bottom of the obstacle, they would be rapidly dislodged by a suction phenomenon attracting them in the channelled flow. This suction phenomenon is the result of a depression created by the increase in the speed of the flow around the obstacle. This speed increase itself is created by the Venturi effect. Hence, such a probe allows efficiently discharging the impurities and, thus, avoiding measurement errors related to these particles.

In the present application, the upstream and the downstream are considered with respect to the channelled flow of the fluid inside the tube. Hence, the stop region and the pressure tap are located before the obstacle in the direction of the flow.

The tube extends along a central axis. It may have any section. In general, the tube has an axisymmetric cylinder general shape, in which case it has as a central axis the axis of revolution and its section is circular. In the present disclosure, an axial direction is a direction parallel to the central axis whereas a radial direction is a direction perpendicular to the central axis. The alignment is assessed according to an axial direction. Thus, the pressure tap and the obstacle are aligned according to an axial direction.

The obstacle forms a projection on the wall meaning that it is in relief with respect to the inner surface of the wall. In other words, in the particular case of a wall defining a cylindrical tube, the front face of the obstacle is located inside the cylindrical volume with a mathematically infinite length delimited by the inner surface of the tube.

The obstacle extends in height, according to a radial or substantially radial direction, from its lower edge which is connected to the wall up to its upper edge which is free. the stop region is located at the bottom of the obstacle, i.e. along the wall at the lower edge of the obstacle, and upstream of the latter. An empty space for the passage of the fluid extends between the upper edge of the obstacle and the wall that surrounds it.

In some embodiments, the front face of the obstacle is delimited in height by an upper edge and a lower edge, and in width by lateral edges. The lower edge is connected to the wall. The upper edge and the lateral edges are free, so that the fluid could flow over the obstacle, between the upper edge and the wall, and over the sides of the obstacle, between the lateral edges and the wall. Such a configuration allows discharging the particles more efficiently by providing for lateral discharge areas on either side of the obstacle.

In contrast with known probes, wherein the bottom of the sensing tube is plugged to stop the flow of the fluid, the proposed probe has a sensing tube open at both of its ends so as to channel the flow of the fluid along the tube, from the upstream end up to the downstream end of the tube and even beyond the downstream end. In the proposed probe, the flow of the fluid is stopped only locally, in a limited region upstream of the obstacle, namely said stop region.

In the present description, the section delimited by the inner wall of the tube and the free (lateral and upper) edges of the obstacle are so-called the “minimum passage section” of the fluid. The surface perpendicular to the flow in the tube when there is no obstacle is so-called the “maximum passage section”.

In some embodiments, the minimum passage section located at the level of the obstacle is at least equal to 20% of the maximum passage section. Hence, the tube is open wide, including at the level of the obstacle, so as to promote the flow of the fluid along the tube.

At present, an airliner may be equipped with two or three probes so as to overcome the failure of one of the probes. For example, the proposed probe could be used as a complement or as a replacement for one of these probes.

Another object of the invention is a pressure measurement system comprising a probe as described before and a pressure sensor pneumatically connected to the pressure tap.

The aforementioned features and advantages, as well as others, will become apparent upon reading the following detailed description of embodiments of the probe. This detailed description refers to the appended drawings.

### BRIEF DESCRIPTION OF THE DRAWINGS

The appended drawings are schematic and are not necessarily plotted to scale, they are primarily intended to illustrate the principles of the invention. In these drawings, from one figure (fig) to the other, identical elements (or portions of elements) are identified by the same reference signs.

FIG. 1 This figure is an axial section of an example of a sensing probe.

FIG. 2 This figure is a right view, according to the arrow II, of the probe of FIG. 1.

FIG. 3 This figure is a detail perspective view of the downstream end of the probe of FIG. 1.

FIG. 4 This figure is an axial section of another example of a sensing probe.

FIG. 5 This figure is a right-side view, according to the arrow V, of the probe of FIG. 4.

FIG. 6 This figure is a detail perspective view of the downstream end of the probe of FIG. 4.

FIG. 7 This figure is a view similar to that of FIG. 6 of one variant.

FIG. 8 This figure is a view similar to that of FIG. 6 of one variant.

FIG. 9 This figure is a view similar to that of FIG. 6 of one variant.

FIG. 10 This figure is an axial section of another example of a sensing probe.

FIG. 11 This figure is a right-side view, according to the arrow XI, of the probe of FIG. 10.

FIG. 12 This figure is a detail top view, according to the arrow XII, of the downstream end of the probe of FIG. 10.

FIG. 13 This figure is a detail view, in axial section, of the downstream end of another example of a sensing probe.

FIG. 14 This figure is a perspective view of FIG. 13.

FIG. 15 This figure is a detail view, in axial section, of the downstream end of another example of a sensing probe.

FIG. 16 This figure is a detail view, in axial section, of the downstream end of another example of a sensing probe.

FIG. 17 This figure shows an example of a sensing probe, in axial section, mounted on the fuselage of an aircraft.

FIG. 18 This figure is a graph representing different measured pressures P, expressed in pascal (Pa), as a function of the Mach number of the flow M0 measured in the flow path of the wind tunnel.

FIG. 19 This figure is a graph representing the Mach number of the flow Mc calculated based on the pressure Pi_S1 measured in the stop region S1, as a function of the Mach number M0 measured in the flow path of the wind tunnel.

FIG. 20 This figure is a graph that represents the rectified Mach number McR derived from the correction method described hereinafter.

### DETAILED DESCRIPTION

Particular embodiments of the probe of the invention are described in detail hereinafter, with reference to the examples shown in the appended drawings. These embodiments and these examples illustrate the features and the advantages of the invention. Nonetheless, it should be recalled that the invention is not limited neither to these particular embodiments nor to the shown examples.

As illustrated in the drawings, the pressure sensing probe 1 comprises a wall 12 defining a tube 10, or sensing tube, into which a fluid can enter. In particular, such a probe 1 can be mounted on a land, air or sea vehicle. In particular, the probe 1 can equip an aircraft like an airplane. In this case, the flowing fluid is air.

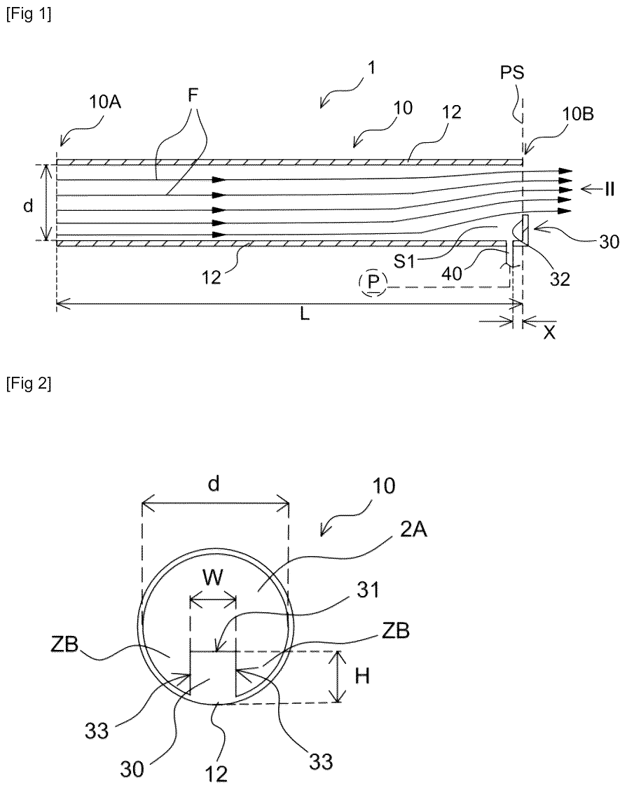

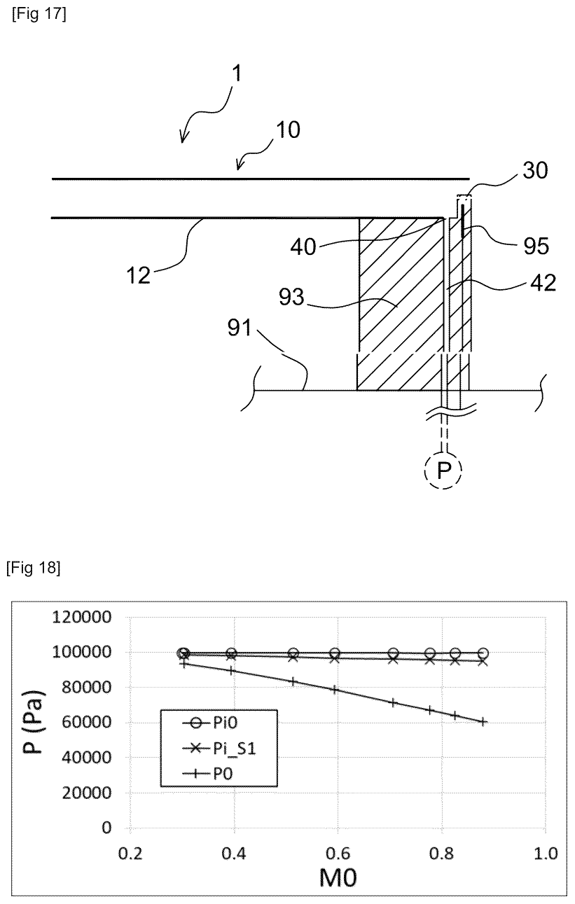

The probe 1 comprises a pressure tap 40 passing through the wall 12. The pressure can be measured from the pressure tap 40 by a pressure sensor P (shown in dotted lines in FIGS. 1 and 17). The pressure sensor P is connected to the pressure tap 40 by a pneumatic connection. In other words, the information is pneumatically transmitted from the pressure tap 40 to the sensor P which performs the pressure measurement. Afterwards, this pressure measurement can serve as a basis for the calculation of the Mach number of the vehicle on which the probe 1 is mounted.

The tube 10 is hollow and open at its two ends 10A, 10B, so as to channel the flow of the fluid along the tube 10. The stream lines F of the flow are represented by arrowed lines in FIGS. 1, 4, 10 and 13. As illustrated, the fluid penetrates into the tube 10 and its flow is channelled along the tube 10. An obstacle 30 projecting from the wall 12 creates a stop region S1 of the fluid upstream and at the bottom of the obstacle 30, while letting the fluid flow around the obstacle 30, i.e. between the obstacle 30 and the wall 12 that surrounds it. For example, the obstacle 30 may be a protuberance or a rising step. The pressure tap 40 is located in alignment with and upstream of the obstacle 30, in the stop region S1.

The length L of the tube 10 is long enough for the incident flow to be channelled and uniform before reaching the obstacle 30. For example, the length L of the tube 10 may be longer than five times the largest dimension of its section. In the examples of the drawings, the tube 10 is cylindrical shaped and has a circular section, so that the largest dimension of its section corresponds to the inner diameter d of the tube 10. Nevertheless, other tube shapes could be considered without departing from the scope of the invention. For example, the tube 10 could include, upstream of its length L a diverging frustoconical shape, to limit the introduction of impurities. Moreover, the leading edge of the front end 10A of the tube 10 could be cut clean, or rounded, to better sense the flow of the fluid in the tube.

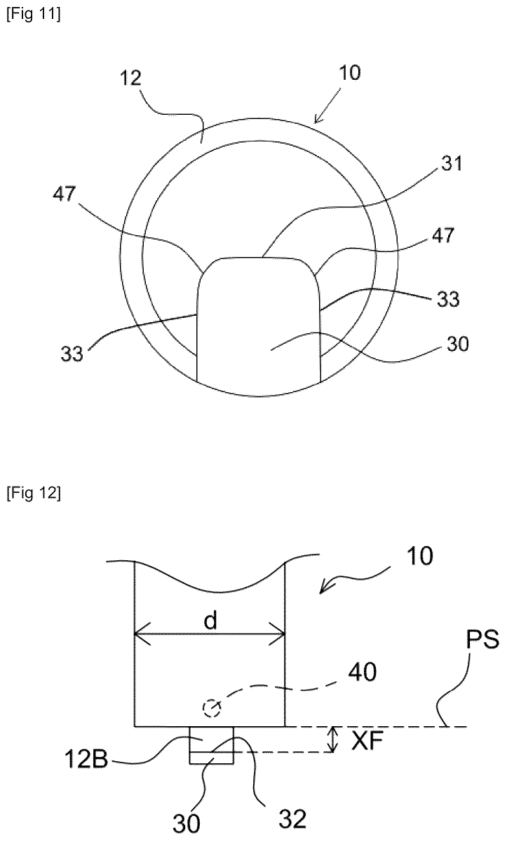

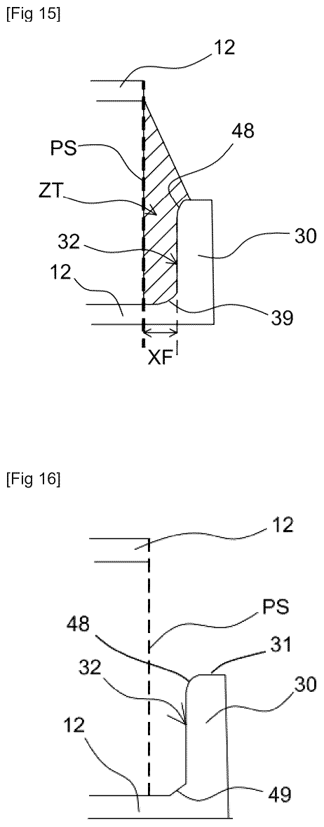

The obstacle 30 has a first face, so-called the front face 32, facing the channelled flow of the fluid and opposing this flow. The front face 32 has a height H and a width W, as shown in FIG. 2. In the examples of the drawings, the obstacle 30 has a substantially constant section, but this is not necessarily the case. For example, the obstacle 30 could become finer downstream. Moreover, the obstacle 30 may have bevelled or rounded edges as shown in FIGS. 11 and 15. Rounding 47, 48 the edges of the front face 32 and the lateral edges 33 of the obstacle allow promoting the discharge of the flow between the obstacle 30 and the wall 12 (FIGS. 11, 15 and 16).

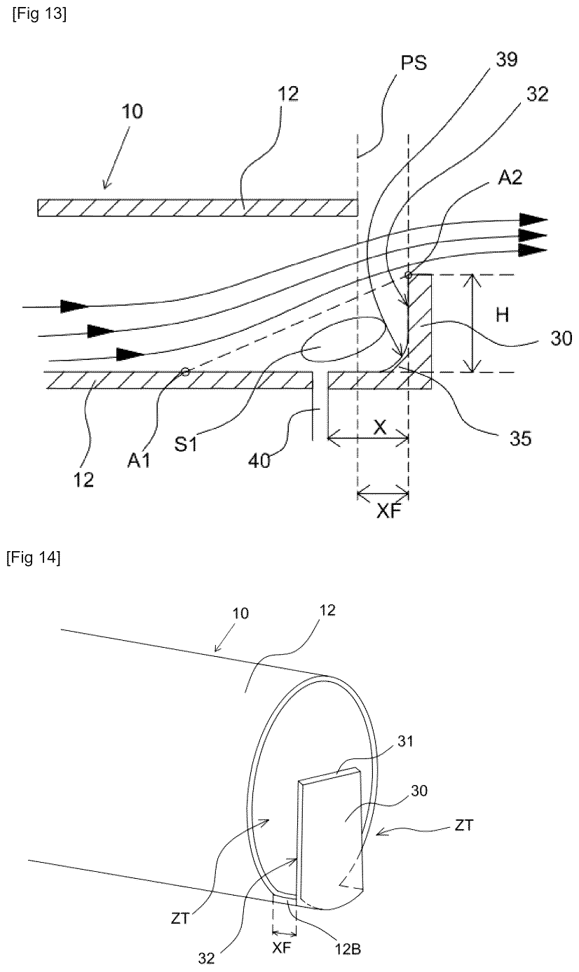

As shown in FIGS. 13, 15 and 16, a rounding 39 or an angle break 49 at the junction of the front face 32 and the wall 12 allows promoting the discharge of the impurities that might temporarily penetrate in the stop region S1.

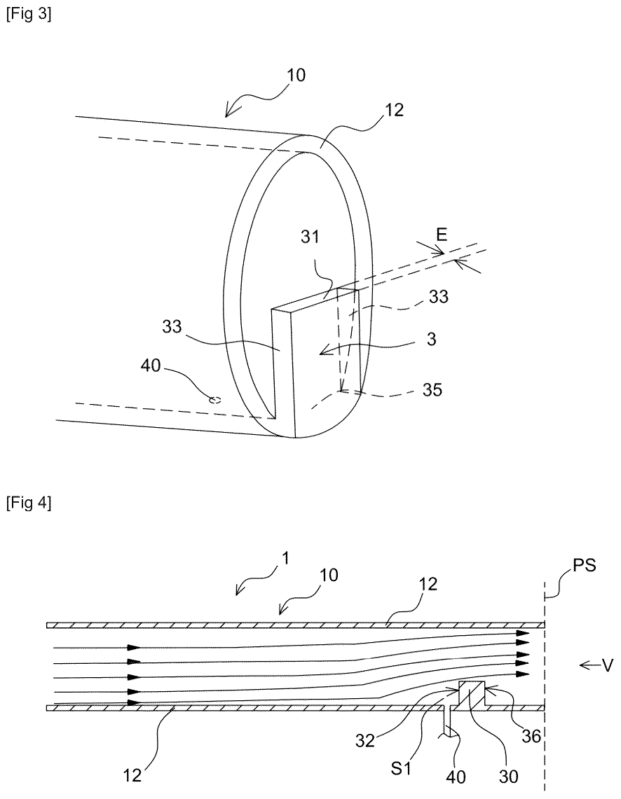

In general, the shape of the obstacle 30 and of its front face 32 may vary. Similarly, the position of the obstacle 30 with respect to the outlet plane PS of the tube 10 may vary. Thus, in the example of FIGS. 1 to 3, the obstacle 30 is fastened to the downstream end 10B of the tube 10 so that the front face 32 of the obstacle is located in the outlet plane PS of the tube 10. It is then said that the obstacle 30 is located “at the outlet” of the tube 10. The obstacle 30 is in the form of a plate and has a thickness E, measured along an axial direction, smaller than the height H and the width W of the obstacle.

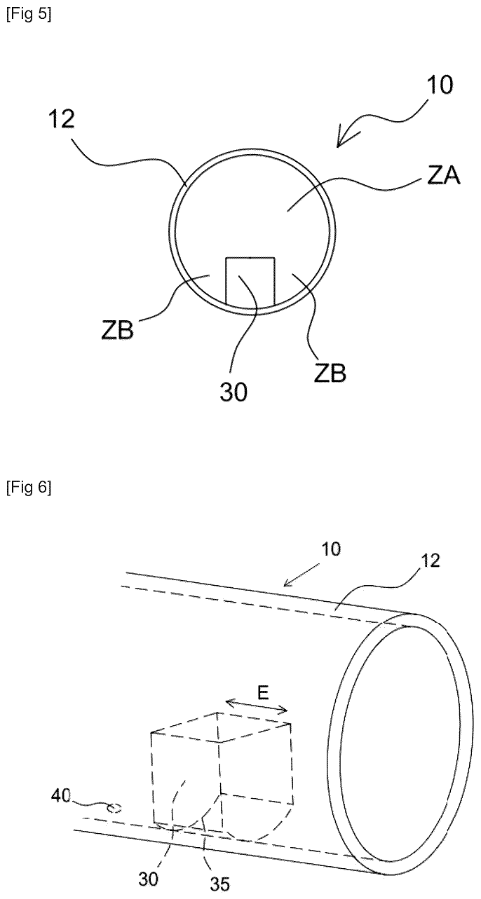

The example of FIGS. 4 to 6 differs from that of FIGS. 1 to 3 in that the obstacle 30 has a larger thickness E so that it has a generally rectangular parallelepiped shape, it being understood that the lower face of this parallelepiped is not planar since it is in contact with the wall 12 and follows the curvature of the wall 12. Moreover, the obstacle 30 is positioned inside the tube 10 so that its rear face 36, or downstream face, is located upstream of the outlet plane PS of the tube 10.

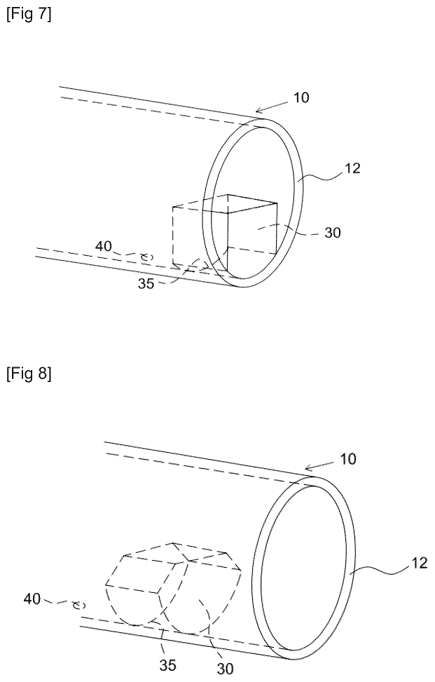

The example of FIG. 7 differs from that of FIGS. 4 to 6 in that, although it is always positioned inside the tube 10, the obstacle is closer to the outlet plane PS of the tube 10. In particular, the rear face 36 of the obstacle 30 is aligned with the outlet plane PS of the tube 10. The rear face 36 of the obstacle 30 could also be located outside the tube without departing from the scope of the invention.

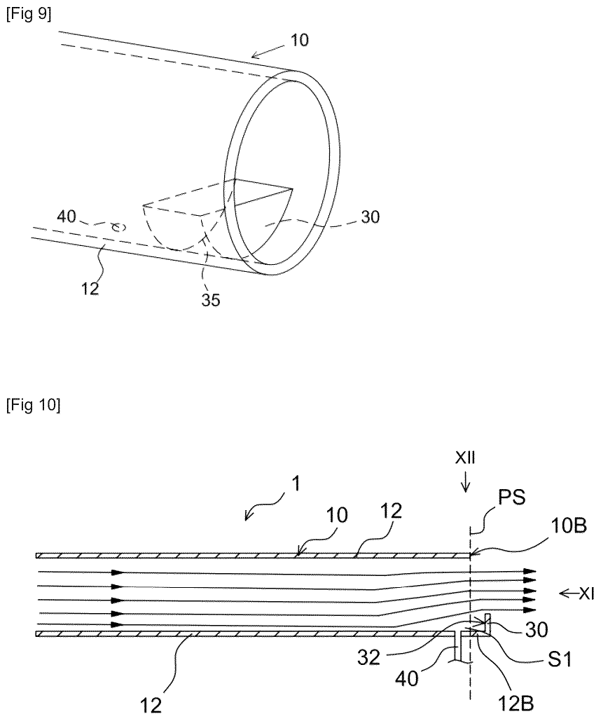

The examples of FIGS. 8 and 9 differ from that of FIGS. 4 to 7 essentially by the shape of the obstacle 30. It should be understood that the obstacle may have different shapes without departing from the scope of the invention, its front face 32 and, more generally, the cross-section of the obstacle 30, could have a rectangular, square, trapezoidal, polygonal, semi-circular, etc., general shape, it being understood that the lower edge 35 of the front face 32 is in contact with the wall 12 and follows the curvature of the latter.

The examples of FIGS. 10 to 16 differ from that of FIGS. 1 to 3 in that the obstacle 30 is in the form of a plate fastened to the downstream end 10B of the tube 10 so that the front face 32 of the obstacle is located downstream of the outlet plane PS of the tube 10 (and not in the outlet plane PS).

In some embodiments, like in the examples of FIGS. 10-16, the downstream end 10B of the tube is delimited by an outlet plane PS, and a portion 12B of the wall 12 extends downstream of the outlet plane PS. In particular, the portion 12B forms a tab extending from one side of the tube 10, in the extension of the latter. The obstacle 30 forms a projection on this wall portion 12B. The front face 32 of the obstacle 30 is located downstream of the outlet plane PS. Thus, there are transverse passage areas ZT between the outlet plane PS and the front face 32 of the obstacle 30, on each side of the obstacle 30. The larger the axial distance XF between the front face 32 and the outlet plane PS, the larger the size of the transverse passage areas ZT will be. The projection of the transverse passage areas ZT in an axial sectional plane passing through the pressure tap 40 is shown hashed in FIG. 15.

The transverse passage areas ZT lead to a larger three-dimensional passage (or discharge) surface than in the configurations where the front face 32 is positioned inside the tube 10 or in the outlet plane PS. The transverse passage areas ZT promote the lateral discharge of the impurities.

In some embodiments, the front face 32 is located downstream of the outlet plane PS such that XF<0.5dS, where XF is the axial distance between the front face 32 and the outlet plane PS and dS the largest dimension of the internal straight section of the tube 10 in the outlet plane PS. In the case where the tube 10 has a circular section, the largest dimension dS of its section corresponds to its inner diameter d. Such a configuration guarantees that the obstacle 30 is located in the channelled flow of the fluid. In other words, the area downstream of the tube 10 in which the obstacle 30 is located is close enough to the outlet plane PS of the tube 10 so that the flow of the fluid is further channelled in this area.

In some embodiments, the front face 32 of the obstacle is delimited in height by an upper edge 31 and a lower edge 35, and in width by lateral edges 33. The lower edge 35 is connected to the wall of the tube 12 whereas the upper edge 31 and the lateral edges 33 are free meaning that they are not connected to the wall of the tube 12, but separated from the latter by an empty space. Hence, there is an upper surface ZA, above the obstacle 30, and lateral surfaces ZB, on either side of the obstacle 30, through which the fluid flows. These surfaces ZA and ZB are shown in FIGS. 2, 5 and 11. The surfaces ZA and ZB are contiguous and planar when the front face 32 of the obstacle 30 is located upstream or in the outlet plane PS of the tube 10 (i.e. when the obstacle 30 is located inside or at the outlet of the tube 10). These surfaces ZA and ZB are contiguous and three-dimensional, when the front face 32 of the obstacle is located downstream of the outlet plane PS of the tube 10, i.e. when there are transverse passage areas ZT.

The tube 10 defines passage sections for the fluid. The surface through which the fluid flows (or is discharged) between the obstacle 30 and the wall 12 of the tube is so-called the passage section. In some embodiments, the tube 10 defines a minimum passage section and a maximum passage section for the fluid, the minimum passage section being located at the level of the obstacle and being at least equal to 20% of the maximum passage section. In the particular case of an axisymmetric cylindrical tube, the maximum passage section may be equal to the surface area of the internal circular section of the tube, namely π·d²/4 where d is the inner diameter of the tube.

In the examples of the figures, the minimum passage section corresponds to the sum of the surfaces ZA and ZB that surround the obstacle.

In the embodiments where the obstacle 30 is located inside or at the outlet of the tube 10, like in the examples of FIGS. 1 to 9, the section of the obstacle, at its front face 32, measures between 20% and 80%, in particular between 30% and 70%, of the passage section of the tube 10 located just upstream of the front face 32. Hence, in the particular case of an axisymmetric cylindrical tube, the section of the obstacle, at its front face 32, measures between 20% and 80% of the internal circular section of the tube.

In some embodiments, the front face 32 of the obstacle 30 is substantially perpendicular to the wall 12 of the tube (in the examples of the drawings, the front face 32 of the obstacle 30 is perpendicular to the wall 12). In particular, the front face may form with the wall 12 an angle comprised between 60° and 120°, in particular between 70° and 110°. A smaller angle might create an impurity retention area at the lower edge 35 of the front face 32, whereas a larger angle might reduce the size of the stop region S1.

More specifically and with reference to FIG. 13 considered as an example, a stop region S1 is created in the vicinity and upstream of the front face 32. The stop region S1 is characterised by a so-called isobaric vortex dead-water area, delimited, in the axial section plane, by a line (shown in dotted lines in FIG. 13) connecting a separation point A1 of the flow to the reattachment point A2 of the flow. The separation point A1 is located on the wall 12 in alignment with and upstream of the obstacle 30. The reattachment point A2 is located toward the top of the obstacle.

The pressure tap 40 should be located in the stop region S1, upstream of the front face 32 of the obstacle and downstream of the separation point A1. The separation point A1 is defined by a zero average coefficient of friction. This separation point A1 could be obtained without any particular difficulty by Navier-Stokes type fluid mechanics calculations within the reach of a person skilled in the art. Thus, the pressure tap 40 senses the pressure denoted Pi_S1 prevailing in the stop region S1.

In some embodiments, the pressure tap 40 is located upstream of the obstacle 30 so that 0.2H≤X≤2H, where X is the axial distance between the pressure tap 40 and the front face 32 of the obstacle, and H the height of the front face. Below 0.2H, the pressure tap 40 is too close to the front face, which poses a risk of temporary clogging by impurities still not discharged. Beyond 2H, the pressure tap 40 runs the risk of being outside the stop region S1. To further reduce these risks, the pressure tap 40 may be located upstream of the obstacle 30 at an axial distance X such that 0.3H≤X≤H.

Moreover, in the stop region S1, it is possible that a secondary vortex is formed in the corner between the front face 32 of the obstacle and the wall 12 intended to channel the flow, i.e. at the lower edge 35 of the front face 32. In some embodiments, to avoid the formation of such a secondary vortex that could promote the accumulation of impurities, an angle break 49 or a properly dimensioned rounding 39 may be formed in the corner at the bottom of the obstacle 30, as illustrated in FIGS. 13, 15 and 16.

FIG. 17 illustrates an example of a probe 1 mounted, via a support 93, on the fuselage 91 of an aircraft. A pneumatic link 42 passes through the support 93 and connects the pressure tap 40 to a pressure sensor P present onboard the aircraft. A heating device like a heating resistor 95 may be integrated with the obstacle 30 in order to increase the temperature of the materials making off the obstacle 30 and thus further limit the risk that condensed phases of the humid or icing air form or persist on contact with the walls of the obstacle 30 and in the stop region S1.

The pressure sensor P (connected to the pressure tap 40) measures the pressure Pi_S1 in the stop region S1 upstream of the obstacle. By applying a correction law described later on, it is then possible to deduce the Mach number of the aircraft, if the static pressure P0 is also measured. For example, the static pressure P0 can be measured using one or more other pressure tap(s) located elsewhere on the fuselage 91.

In comparison with a Pitot probe of the prior art, the proposed probe 1 allows avoiding the pressure sensing being exposed frontally to the flow and establishing a more efficient discharge of impurities. The probe 1 may have a general shape similar to that of a Pitot probe and integrate in the same manner to an aircraft or any other vehicle. Hence, it could be mounted as a replacement of a Pitot probe. The probe 1 may be fixedly mounted on a vehicle because it allows for a reliable measurement of the stop pressure for a range of incidence or sideslip of + or −15°. The probe 1 may also be mounted on a vane. These features meet the constraints set by manufacturers to re-equip existing airplanes.

The quality and the reliability of the pressure measurements performed by means of the proposed probe 1 have been assessed during wind tunnel tests.

These tests have been carried out for several Mach numbers in the “ONERA-S3Ch” transonic wind tunnel, which comprises a return circuit provided with a thermal regulation and a test flow path with a 0.80 m×0.76 m sized rectangular section, powered by a motor outputting up to 3.5 MW of power.

The tested probe 1 has a general shape identical to that of FIGS. 1 to 3, namely shaped as a hollow axisymmetric cylindrical tube, with a length L=120 mm, and an internal diameter d=18 mm. The obstacle 30 is in the form of a rectangular plate with a height H=10 mm, a width W=12 mm and a thickness E=1 mm. To make a probe at a smaller scale, it is possible, for example, to proceed with a homothety of the tested probe in all space directions.

FIG. 18 shows the pressure measurements made during a test sequence, carried out for a Mach range from 0.3 to 0.9. In this figure, are given the static pressure P0 measured in the wind tunnel, the generator pressure Pi0 measured in the wind tunnel and the pressure Pi_S1 measured in the stop region S1 of the probe. Other test sequences have allowed demonstrating the good repeatability of the measurement of the pressure Pi_S1 in the stop region S1.

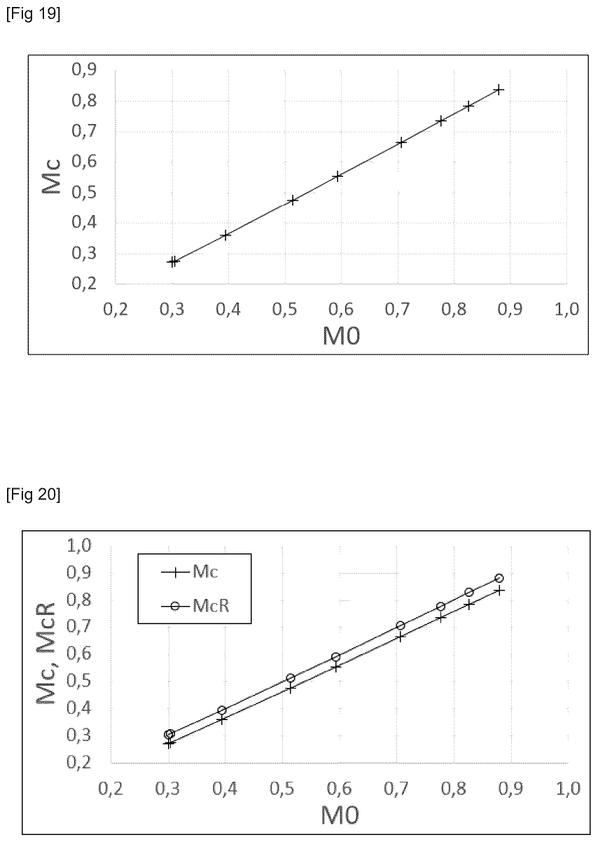

FIG. 19 shows a comparison between the Mach number M0 measured in the flow path of the wind tunnel and the Mach number Mc calculated based on the measured pressure Pi_S1.

The difference between the two Mach numbers M0 and Mc is related to the difference between the two measurements of the stop pressure, that one measured in the wind tunnel denoted Pi0 and that one measured by the probe denoted Pi_S1. Nonetheless, the difference between the measurements of Pi0 and Pi_S1 is relatively low. This difference is almost linear. The least squares straight line gives a multiple correlation coefficient R² of 0.9996. The difference between the Mach numbers M0 and Mc is also almost linear. The least squares straight line gives a multiple correlation coefficient R² of 0.9999. Hence, these differences are not important as such since, because of their monotonic and almost linear evolution, they can be easily corrected by correction laws. Thus, in some embodiments, a linear correction law is used for the pressure measurement Pi_S1 or for the dynamic pressure Q0_S1 derived from the pressure measurement Pi_S1. Thus, we end up with the determination of a rectified dynamic pressure, Q0_R.

The steps for applying this correction are as follows:
(Step 1) Calculating the Mach number Mc with the static pressure P0 measured in the wind tunnel, and the stop pressure Pi_S1 measured by the probe (which is considered as an approximate measurement of the stop pressure) using the following relationship.

$$M c = \sqrt{5 [ {\frac{P 0}{Pi\_S 1}}^{- ( 2 / 7 )} - 1 ]} . \qquad [ Math . 1 ]$$

(Step 2) Calculating the dynamic pressure Q0_S1 with Mc using the following relationship.

Q0_S1=0.7P0(Mc)² [Math.2]
(Step 3) Applying a correction law to calculate a rectified dynamic pressure Q0_R. Such a correction law is established beforehand, upon completion of calibration tests carried out in a wind tunnel. For example, the correction law is linear-shaped with parameters a and b, so that:

Q0_R=aQ0_S1+b [Math.3]
(Step 4) Calculating the rectified Mach number McR based on Q0_R using the following relationship.

$$McR = \sqrt{\frac{Q0\_R}{0.7 P 0}} \qquad [ Math . 4 ]$$

By applying these steps, a value of the rectified flow Mach number McR within a 0.002 margin from the actual Mach number M0 has been obtained. This is illustrated in FIG. 20 which shows the effectiveness of the proposed correction. Such a result perfectly meets the current accuracy requirements for the Mach number measurement, in particular in the aeronautics field.

The embodiments described in the present disclosure are given for illustrative and non-limiting purposes, a person skilled in the art can easily, in view of this disclosure, modify these embodiments, or envision others, while remaining within the scope of the invention.

In particular, a person skilled in the art could readily consider variants comprising only part of the features of the previously-described embodiments, if these features alone are sufficient to achieve one of the advantages of the invention. In addition, the different features of these embodiments can be used alone or be combined together. When combined, these features can be as described hereinabove or otherwise, the invention not being limited to the specific combinations described in the present disclosure. In particular, unless specified otherwise, a feature described in connection with an embodiment can be applied in a similar manner to another embodiment.

1. A pressure sensing probe comprising:
a wall defining a tube into which a fluid can enter; and
a pressure tap passing through the wall, from which tap the pressure is measured;
wherein the tube is open at both of its ends so as to channel the flow of the fluid along the tube,
wherein the probe comprises an obstacle having a front face which faces the channelled flow of the fluid and opposes this flow, the obstacle forming a projection on the wall and being dimensioned so as to create a stop region of the fluid upstream and at the bottom of the front face, while enabling the fluid to flow around the obstacle, between the obstacle and the wall,
wherein the pressure tap is located in alignment with and upstream of the obstacle, in the stop region.

2. The probe according to claim 1, wherein the front face of the obstacle is delimited in height by an upper edge and a lower edge, and in width by lateral edges, wherein the lower edge is connected to the wall, and wherein the upper edge and the lateral edges are free, so that the fluid can flow over the obstacle, between the upper edge and the wall, and over the sides of the obstacle, between the lateral edges and the wall.

3. The probe according to claim 1, wherein the tube delimits a minimum passage section and a maximum passage section for the fluid, the minimum passage section being located at the level of the obstacle and being at least equal to 20% of the maximum passage section.

4. The probe according to claim 1, wherein the front face of the obstacle is substantially perpendicular to the wall.

5. The probe according to claim 1, wherein the obstacle is located inside or at the outlet of the tube and wherein the section of the obstacle, at its front face, measures between 20% and 80% of the passage section of the tube located just upstream of the front face.

6. The probe according to claim 1, wherein the downstream end of the tube is delimited by an outlet plane of the tube, wherein a portion of the wall extends downstream of the outlet plane, wherein the obstacle is connected to the wall portion, and wherein the front face is located downstream of the outlet plane.

7. The probe according to claim 6, wherein the front face is located downstream of the outlet plane so that XF<0.5dS, where XF is the axial distance between the front face and the outlet plane and dS the largest dimension of the section of the tube in the outlet plane.

8. The probe according to claim 1, wherein the pressure tap is located upstream of the obstacle so that 0.2H≤XP≤2H, where XP is the axial distance between the pressure tap and the front face of the obstacle, and H the height of the front face.

9. A pressure measurement system comprising a probe according to claim 1, and a pressure sensor pneumatically connected to the pressure tap.
